(19) United States
(12) Patent Application Publication
(10) Pub. No.: US 2012/0248653 A1
(43) Pub. Date: Oct. 4, 2012

(54) METHOD OF OPERATING A MOLDING SYSTEM

(75) Inventors: Tiemo Dietmar Brand, North York (CA); Douglas James Weatherall, Bolton (CA)

(73) Assignee: Husky Injection Molding Systems Ltd., Bolton, ON (CA)

(21) Appl. No.: 13/125,321

(22) PCT Filed: Oct. 15, 2009
(86) PCT No.: PCT/CA2009/001436

§ 371 Date: Apr. 21, 2011

Related U.S. Application Data
(60) Provisional application No. 61/118,667, filed on Dec. 1, 2008.

(51) Int. Cl. B29C 45/72; B29C 45/76

(52) U.S. Cl. 264/328.14; 425/149

(57) ABSTRACT

According to embodiments of the present invention, there is provided a method of operating a molding system. More specifically the method of operating a melt distribution network within a molding system, the melt distribution network including a first melt flow control device at an upstream location and a second melt flow control device at a downstream location, is provided. The method comprises actuating the first melt flow control device to its open configuration and actuating the second melt flow control device to its open configuration to connect a source of molding material with a molding cavity via the melt distribution network; actuating the second melt flow control device to its blocked configuration; actuating the first melt flow control device to its blocked configuration; said actuating the second melt flow control device and said actuating the first melt flow control device to their respective blocked configurations resulting in molding material being trapped therebetween at a trapped pressure that substantially equals to a last pressurized portion of a molding cycle pressure, said trapped pressure being maintained until a beginning of a next injection cycle.

### FIELD OF THE INVENTION

The present invention generally relates to, but is not limited to, molding systems, and more specifically the present invention relates to, but is not limited to, a method of operating a molding system.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from polyethylene terephthalate (PET) material (or other suitable materials) is a preform that is capable of being subsequently blown into a beverage container, such as, a bottle and the like.

As an illustration, injection molding of PET material involves heating the PET material to a homogeneous molten state and injecting, under pressure, the so-melted PET material into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected off of the core piece. Ejection structures are known to assist in removing the molded articles from the core halves. Examples of the ejection structures include stripper plates, ejector pins, robots, etc.

As is known in the art, within a multi-cavity mold a hot runner system is typically employed to convey molding material (such as aforementioned PET and the like) from a plasticizing unit to the molding cavities defined within the multi-cavity mold. Several types of the hot runner arrangement are known in the art and, as far as gating technology is concerned, they can be broadly categorized into valve-gated and thermally-gated hot runners. With certain designs of the hot runner, it has been known to decompress the melt stream within the hot runner at certain points in the injection molding cycle. This has been done to achieve several goals, such as inter alia: to mitigate stringing, drooling and other defects. However, melt decompression performed cyclically (i.e. cycle after cycle), results in considerable waste of energy and potentially time due, at least partially, to having to build up pressure at the beginning of the next cycle.

U.S. Pat. No. 4,272,236 issued to Rees et al. on Jun. 9, 1981 discloses a nozzle for the introduction of liquefied plastic material into a mold that has a channel terminating at one end in an injection orifice and adjoining at its other end a reduced bore serving for the guidance of a valve pin slidable with all-around clearance in that channel, the pin having a rear extremity projecting from its guide bore. A passage for the admission of liquefied molding material under pressure enters the channel at its junction with the reduced guide bore, rearwardly of a set of skew fins of the pin serving for additional guidance thereof in the channel and for imparting relative rotary motion to the flow and the pin. The orifice is blocked at the end of an injection operation by a pusher acting upon the projecting rear extremity; it is unblocked, upon withdrawal of the pusher, by the pressure of the molding material in the channel upon a forwardly facing annular shoulder of the pin.

U.S. Pat. No. 6,649,094 issued to Galt et al. on Nov. 18, 2003 discloses methods for enhanced purging of an injection molding shooting pot assembly are provided. Old melt is purged from a shooting pot having an injection plunger slidably received in an injection cylinder. The plunger is moved by a powered piston, which moves the injection plunger to a purging position. The plunger is then arrested in the purging position. Sufficient new melt is injected through an inlet positioned such that the new melt sweeps substantially an entire volume of the injection cylinder ahead of the injection plunger in flowing between the inlet and a single outlet remote from the inlet.

U.S. Pat. No. 7,270,537 issued to Doyle et al. on Sep. 19, 2007 discloses an injection molding machine having upstream and downstream channels communicating with each other for delivering fluid material to one or more mold cavities, and an apparatus for controlling delivery of the melt material from the channels to the one or more mold cavities, each channel having an axis, the downstream channel having an axis intersecting a gate of a cavity of a mold, the upstream channel having an axis not intersecting the gate and being associated with an upstream actuator interconnected to an upstream melt flow controller disposed at a selected location within the upstream channel, the apparatus comprising a sensor for sensing a selected condition of the melt material at a position downstream of the upstream melt flow controller; an actuator controller interconnected to the upstream actuator, the actuator controller comprising a computer interconnected to a sensor for receiving a signal representative of the selected condition sensed by the sensor, the computer including an algorithm utilizing a value indicative of the signal received from the sensor as a variable for controlling operation of the upstream actuator; wherein the upstream melt flow controller is adapted to control the rate of flow of the fluid material at the selected location within the upstream channel according to the algorithm.

U.S. Pat. No. 7,306,455 issued to Dewar et al. on Dec. 11, 2007 discloses an injection molding apparatus that includes a nozzle having a nozzle channel, a mold cavity in communication with the nozzle channel of the nozzle for receiving a melt stream of moldable material from the nozzle channel through a mold gate; and a valve pin that is axially movable through the nozzle channel of the nozzle between a first retracted position in which the valve pin closes the mold gate to block melt flow between the nozzle channel and the mold cavity, an extended position in which an end portion of the valve pin extends through the mold gate and into the mold cavity, and a third retracted position in which the end portion of the nozzle pin is withdrawn from the mold cavity into the nozzle and spaced apart from the mold gate thereby opening the mold gate. The end portion of the valve pin defines a melt flow path on an outer surface thereof that extends through the mold gate when the valve pin is in the extended position for transmitting the melt stream from the nozzle channel to the mold cavity when the valve pin is in the extended position.

PCT patent application bearing a publication number WO 07029184 A2 published on Mar. 15, 2007 to Enrietti discloses a cylindrical switch (40) that has one or more passages (42, 43) which open onto a lateral cylindrical surface (41) of the switch. The switch is capable of being tightly received in a cylindrical hole (18) in a hot plate (10) and of being selectively orientated so that the passages (42, 43) are angularly in line with or offset from two or more channels (15-17) in the hot plate which open onto the hole (18) in order to selectively permit, interrupt or divert the flow of molten plastics material between the aforesaid channels. The switch incorporates a circuit (50) for a cooling fluid.

U.S. Pat. No. 4,717,324 issues to Schad et al. on Jan. 5, 1998 teaches an apparatus for coinjecting a plurality of thermoplastic materials to mold an article having a layered wall structure using thermoplastic material having different optimum processing temperatures including the maintenance of the optimum temperatures in flow paths individual to each material from its source to a mold cavity.

U.S. Pat. No. 4,080,147 issued to Dumortier on Mar. 21, 1978 teaches a device for the fabrication of hollow plastic bodies, of the type comprising a core carrying plate, a double mould plate, means to inject plastic material into said mould plate and means to press said three plates against each other at the proper time, characterized in that it further comprises a metering plate fixed to one of said mould plates, as well as a hydraulic metering control plate facing said metering plate, said metering plate and hydraulic control plate being so conditioned to introduce, in a first step, a metered quantity of material in said metering plate and to transfer, in a second step, this quantity of material from the metering plate into the mould carrying plate, before the force-dieing resulting from pressing said plates together.

U.S. Pat. No. 6,099,769 issued to Koch on Aug. 8, 2000 teaches a process whereby a first mold cavity is filled via a feeding unit in engagement with a first mold cavity with plastic containing a volume expanding agent, the filled first mold cavity and feeding unit are moved away from each other and a second mold cavity and the feeding unit are moved into engagement with each other, the second mold cavity is filled with plastic containing a volume expanding agent via the feeding unit, the plastic is expanded in the first mold cavity via the volume expanding agent while the second mold cavity is in engagement with the feeding unit, and the expanded article is ejected from the first mold cavity.

US patent application 2008/0274224 published to Graetz et al. on Nov. 6, 2008 teaches an injection nozzle is provided having a nozzle body, defining an inlet channel, an outlet channel and a connecting channel therebetween for communicating a working fluid into and out of the nozzle body. A shut-off pin is slidably mounted within the nozzle body and having a spigot mounted thereto. The shut-off pin is movable between a closed position, where the working fluid is substantially blocked from moving from the inlet channel to the outlet channel, and an open position where the spigot is withdrawn, unblocking the working fluid from moving from the inlet channel to the outlet channel. An actuator is operably connected to the shut-off pin to move the shut-off pin from the open position to the closed position. Moving the shut-off pin from the open position to the closed position generates a region of low pressure in the working fluid in the portion of working fluid trailing the spigot.

### SUMMARY OF THE INVENTION

According to a first broad aspect of the present invention, there is provided a method of operating a melt distribution network within a molding system, the melt distribution network including a first melt flow control device at an upstream location and a second melt flow control device at a downstream location. The method comprises actuating the first melt flow control device to its open configuration and actuating the second melt flow control device to its open configuration to connect a source of molding material with a molding cavity via the melt distribution network; actuating the second melt flow control device to its blocked configuration; actuating the first melt flow control device to its blocked configuration; the actuating the second melt flow control device and the actuating the first melt flow control device to their respective blocked configurations resulting in molding material being trapped therebetween at a trapped pressure that substantially equals to a last pressurized portion of a molding cycle pressure, the trapped pressure being maintained until a beginning of a next injection cycle.

According to a second broad aspect of the present invention, there is provided a controller for controlling operation of a melt distribution network within a molding system, the melt distribution network including a first melt flow control device at an upstream location and a second melt flow control device at a downstream location. The controller is configured to actuate the first melt flow control device to its open configuration and actuating the second melt flow control device to its open configuration to connect a source of molding material with a molding cavity via the melt distribution network; actuate the second melt flow control device to its blocked configuration; actuate the first melt flow control device to its blocked configuration; thereby causing molding material being trapped at a trapped pressure that substantially equals to a last pressurized portion of a molding cycle pressure, the trapped pressure being maintained until a beginning of a next injection cycle.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 depicts schematic representation of a molding system 100, implemented in accordance with a non-limiting embodiment of the present invention.

FIG. 2 depicts a schematic representation of a hot runner 200 of the molding system 100, the hot runner 200 implemented in accordance with a non-limiting embodiment of the present invention.

FIG. 3 depicts a flow chart illustrating a method 300, implemented in accordance with a non-limiting embodiment of the present invention.

FIG. 4 depicts a graph, which illustrates melt pressure behavior during certain portions of the injection molding cycle in the prior art approaches and in accordance with embodiments of the present invention.

FIG. 5A, FIG. 5B and FIG. 5C depict a non-limiting embodiment of a valve 502, which can be used in certain embodiments of the present invention.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF EMBODIMENTS

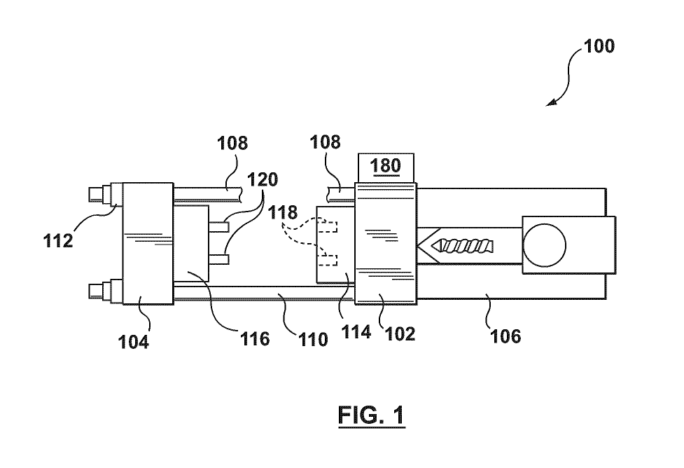

With reference to FIG. 1, there is depicted a non-limiting embodiment of a molding system 100, which can be adapted to implement embodiments of the present invention. For illustration purposes only, it shall be assumed that the molding system 100 comprises an injection molding system for processing molding material, such as, a compressible polymer material. Examples of compressible polymer materials include, but are not limited to, PET, PP and the like. However, it should be understood that in alternative non-limiting embodiments, the molding system 100 may comprise other types of molding systems, such as, but not limited to, compression molding systems, transfer molding systems and the like. It should be further understood that embodiments of the present invention are applicable to the molding system 100 incorporating any multicavitation mold, including PET molds, thinwall articles molds, closures molds and the like.

Within the non-limiting embodiment of FIG. 1, the molding system 100 comprises a fixed platen 102 and a movable platen 104. The molding system 100 further comprises an injection unit 106 for plasticizing and injection of molding material. The injection unit 106 can be implemented as a single-stage injection unit (i.e. reciprocating screw injection unit) or as a two-stage injection unit (i.e. with a dedicated plasticizing unit and a shooting pot). In operation, the movable platen 104 is moved towards and away from the fixed platen 102 by means of stroke cylinders (not shown) or any other suitable means. Clamp force (also referred to as closure or mold closure tonnage) can be developed within the molding system 100, for example, by using tie bars 108, 110 (two of which are shown in FIG. 1) and a tie-bar clamping mechanism 112, as well as (typically) an associated hydraulic system (not depicted) that is usually associated with the tie-bar clamping mechanism 112. It will be appreciated that clamp tonnage can be generated using alternative means, such as, for example, using a toggle-clamp arrangement (not depicted) or the like.

A first mold half 114 can be associated with the fixed platen 102 and a second mold half 116 can be associated with the movable platen 104. In the specific non-limiting embodiment of FIG. 1, the first mold half 114 comprises a plurality of mold cavities 118. As will be appreciated by those of skill in the art, the plurality of mold cavities 118 may be formed by using suitable mold inserts or any other suitable means. As such, the first mold half 114 can be generally thought of as a “mold cavity half”. The second mold half 116 comprises a plurality of mold cores 120 complementary to the plurality of mold cavities 118. As will be appreciated by those of skill in the art, the plurality of mold cores 120 may be formed by using suitable mold inserts or any other suitable means. As such, the second mold half 116 can be generally thought of as a “mold core half”.

The first mold half 114 can be coupled to the fixed platen 102 by any suitable means, such as a suitable fastener (not depicted) or the like. The second mold half 116 can be coupled to the movable platen 104 by any suitable means, such as a suitable fastener (not depicted) or the like. It should be understood that in an alternative non-limiting embodiment of the present invention, the position of the first mold half 114 and the second mold half 116 can be reversed and, as such, the first mold half 114 can be associated with the movable platen 104 and the second mold half 116 can be associated with the fixed platen 102.

In an alternative non-limiting embodiments of the present invention, the fixed platen 102 need not be stationary and may as well be moved in relation to other components of the molding system 100.

FIG. 1 depicts the first mold half 114 and the second mold half 116 in a so-called “mold open position” where the movable platen 104 is positioned generally away from the fixed platen 102 and, accordingly, the first mold half 114 is positioned generally away from the second mold half 116. For example, in the mold open position, a molded article (not depicted) can be removed from the first mold half 114 and/or the second mold half 116.

In a so-called “mold closed position” (not depicted), the first mold half 114 and the second mold half 116 are urged together (by means of movement of the movable platen 104 towards the fixed platen 102) and cooperate to define (at least in part) a plurality of molding cavities (not depicted) into which the molten plastic (or other suitable molding material) can be injected, as is known to those of skill in the art. It should be appreciated that one of the first mold half 114 and the second mold half 116 can be associated with a number of additional mold elements, such as for example, one or more leader pins (not depicted) and one or more leader bushings (not depicted), the one or more leader pins cooperating with one more leader bushings to assist in alignment of the first mold half 114 with the second mold half 116 in the mold closed position, as is known to those of skill in the art.

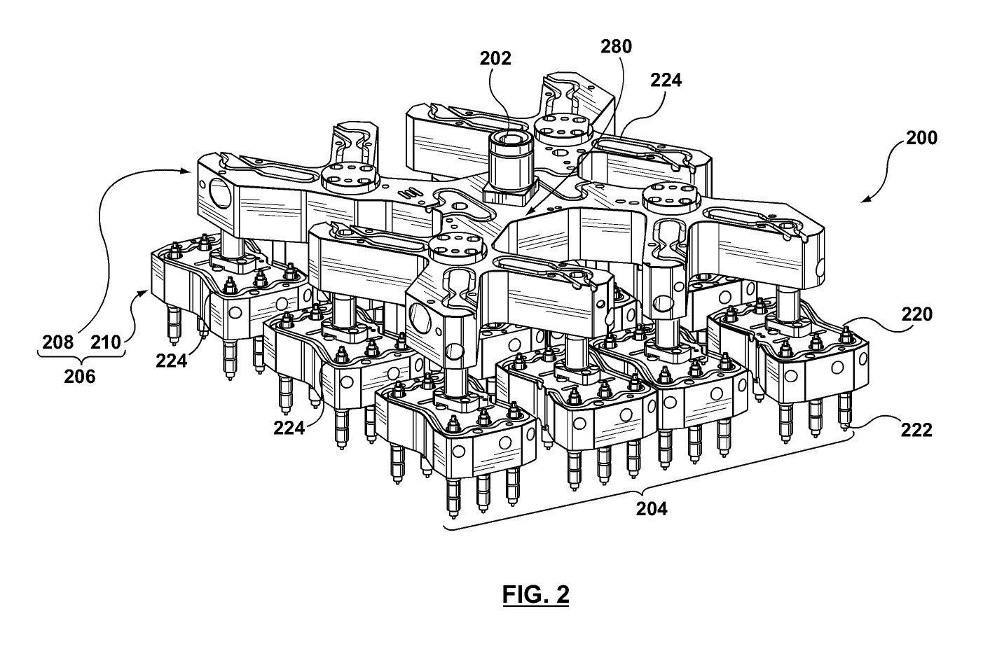

Within embodiments of the present invention, the first mold half 114 can be associated with a hot runner (not separately depicted or numbered in FIG. 1), which is configured to convey molding material from the injection unit 106 to each of the plurality of molding cavities (defined, in use, between the plurality of mold cavities 118 and the plurality of mold cores 120). An example of a hot runner 200 that can be used with the first mold half 114 will now be described in greater detail with reference to FIG. 2. FIG. 2 depicts a schematic representation of a hot runner 200. The hot runner 200 is typically embedded in one or more plates (not depicted).

The hot runner 200 comprises a melt inlet 202 and a plurality of melt outlets 204. The melt inlet 202 is also referred to by those of skill in the art as a “sprue bushing” and is configured to cooperate, in use, with a machine nozzle (not depicted) of the injection unit 106 to provide a point of entry for the melt flow into the hot runner 200. As those skilled in the art will appreciate, the melt inlet 202 cooperates with the machine nozzle (not depicted) to provide effective sealing to substantially prevent any spillage of the melt.

Each of the plurality of melt outlets 204 will be referred to herein below as a melt outlet 204, however, those of skill in the art sometimes also refer to the melt outlet 204 as a “drop”. Each of the plurality of melt outlets 204 is configured to cooperate, in use, with a molding cavity (defined, in use, at least partially between the plurality of mold cavities 118 and the plurality of mold cores 120) to provide a point of exit for the melt from the hot runner 200. Even though not visible in FIG. 2, each of the plurality of melt outlets 204 defines an internal flow channel (not depicted) for the melt and terminating at an orifice (not separately numbered) of a nozzle tip 222.

In the specific non-limiting embodiment depicted in FIG. 2, each of the plurality of melt outlets 204 is also associated with a valve stem 220 disposed, at least partially, within the internal flow channel (not depicted). The valve stem 220 is actuatable between a closed position and an open position. In the closed position, the valve stem 220 substantially obstructs the orifice (not separately numbered) associated with the nozzle tip 222 to substantially prevent flow of the molding material. In the open position, the valve stem 220 substantially un-obstructs the orifice (not separately numbered) associated with the nozzle tip 222 to allow for the molding material to flow. Even though not shown in FIG. 2, the valve stem 220 can be actuated by any known actuator, such as piston-type actuators and the like. In alternative non-limiting embodiments of the present invention, the nozzle tip 222 can be “thermally gated” and within those embodiments of the present invention, the valve stem 220 (and the associated actuators) can be omitted.

The melt inlet 202 is fluidly coupled to the plurality of melt outlets 204 via a network of runners 206. In the specific non-limiting embodiments depicted with reference to FIG. 2, the network of runners 206 comprises a first level sub-network 208 and a second level sub-network 210. The first level sub-network 208 is fluidly coupled to the melt inlet 202. The second level sub-network 210 is fluidly connected to the first level sub-network 208 and to the plurality of melt outlets 204.

There is also provided a plurality of heater receptacles 224, only some of which are numbered in FIG. 2 for the sake of ease of illustration. More specifically, some of the plurality of heater receptacles 224 is located in the first level sub-network 208 and some of the plurality of heater receptacles 224 is located in the second level sub-network 210. The plurality of heater receptacles 224 is configured to accept, in use, a plurality of heaters (not depicted) that are configured to provide heating to maintain a target temperature associated with the molding material flowing via the network of runners 206.

It can be said that within embodiments of the present invention, portions of the first mold half 114, the hot runner 200 and the injection unit 106 that convey molding material can be considered as part of the melt distribution network for conveying molding material. The melt distribution network can be said to have an upstream location and a downstream location, the terms “upstream” and “downstream” referring to the direction of the flow of the molding material (typically, from the injection unit 106 towards the molding cavities defined between the plurality of mold cores 120 and the plurality of mold cavities 118).

According to embodiments of the present invention, there are provided a first melt flow control device at an upstream location and a second melt flow control device at a downstream location within the melt distribution network. In the example to be illustrated herein below, it shall be assumed that the first melt flow control device and the second melt flow control device are positioned at an upstream location and a downstream location, respectively, within the hot runner 200. However, as will be shown herein below, this needs not be so in every embodiment of the present invention.

Generally speaking, the purpose of the first melt flow control device and the second melt flow control device is to selectively restrict (and, accordingly, selectively allow) the flow of the molding material via the melt distribution network. As will be shown herein below, it is contemplated that the first melt flow control device and the second melt flow control device can be implemented as follows (including all conceivable combinations between the two lists):

For the first melt flow control device (i.e. the upstream location):
A valve;
A screw of the injection unit 106 in those embodiments where the injection unit is implemented as a single stage injection unit;
A distributor and/or a plunger of the shooting pot of the injection unit 106 in those embodiments where the injection unit is implemented as a two-stage injection unit.
   For the second melt flow control device (i.e. the downstream location):
A valve;
A valve stem 220 in the valve-gated implementation of the nozzle tip 222.
   Within those embodiments of the present invention where a valve is used to implement the second melt flow control device, it can be positioned at a given downstream location selected from:
between the plurality of melt outlets 204 and the second level sub-network 210;
within the second level sub-network 210;
between the second level sub-network 210 and the first level sub-network 208;
within the first level sub-network 208;
between the first level sub-network 208 and a molding machine nozzle (not depicted).

In some embodiments of the present invention, the valve used can be a stop valve. In embodiments of the present invention, an off-the-shelf valve can be used.

Naturally, combinations and permutations of the above-referenced examples are possible. Just as a non-limiting example, description to be presented herein below will use an example, where:
the second melt flow control device is implemented as a plurality of second melt flow control devices and, more specifically, an example where each of the plurality of second melt flow control devices is realized as a given one of the plurality of valve stems 220 associated with the plurality of melt outlets 204; and
the first melt flow control device is implemented as a valve positioned within network of runners 206 in a close proximity to the melt inlet 202, for example, at a location depicted in FIG. 2 at 280.

Returning to the description of FIG. 1, the molding system 100 further comprises a controller 180, which is configured to control one or more routines executed by the molding system 100. The controller 180 can be implemented as a general-purpose or a proprietary computing apparatus. Some examples of the routines that can be controlled by the controller 180 include, but are not limited to: opening and closing of the first mold half 114 and the second mold half 116, varying the speed of the injection unit 106, carrying and/or maintaining temperature associated with some or all of the heaters (not depicted) received, in use, within the plurality of heater receptacles 224, opening and closing of the plurality of valve stems 220 and other functions known to those skilled in the art, as well as functions to be described herein below.

The molding system 100 can further include a number of additional components, such as take out devices, post-mold treatment devices, dehumidifiers and the like, all of which are known to those of skill in the art and, as such, have been omitted from this description. It should be expressly understood that the molding system 100 may have other configurations and the description presented above has been provided as an example only and is not intended to be limiting in any form. In other non-limiting embodiments of the present invention, the molding system 100 can have other configurations with more or fewer components.

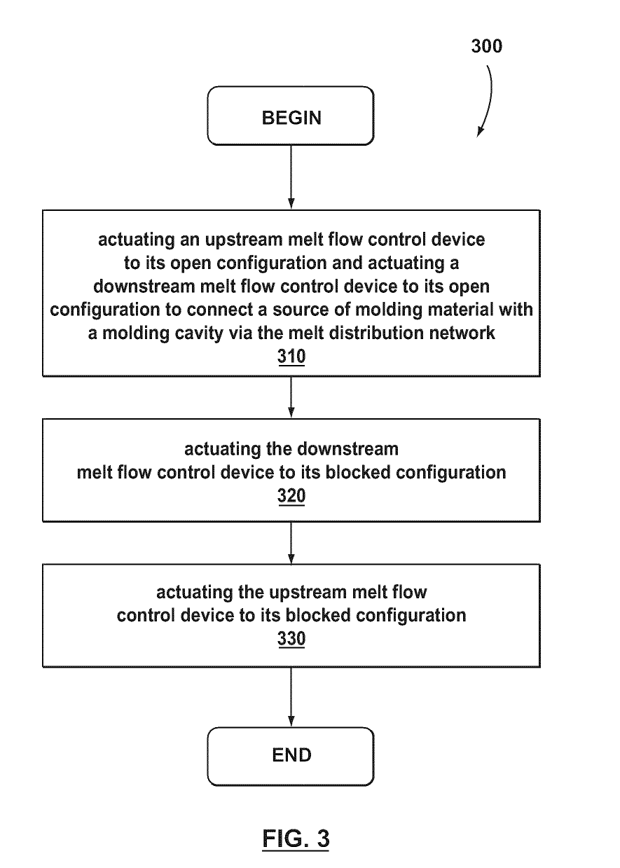

Given this architecture, it is possible to implement a method of operating a melt distribution network in accordance with a non-limiting embodiment of the present invention. A non-limiting embodiment of a method 300 will now be described in greater detail with reference to FIG. 3. The method 300 can be conveniently executed by the controller 180.

Step 310—Actuating the Upstream Melt Flow Control Device to its Open Configuration and Actuating the Downstream Melt Flow Control Device to its Open Configuration to Connect a Source of Molding Material with a Molding Cavity Via the Melt Distribution Network

The method 300 starts at step 310, where the controller 180 actuates the upstream melt flow control device to its open configuration and actuates the downstream melt flow control device to its open configuration to connect a source of molding material with a molding cavity via the melt distribution network. In the example being considered herein, actuating the downstream melt flow control device to its open configuration comprises actuating the plurality of valve stems 220 to an open configuration. Similarly, actuating the upstream melt flow control device to its open configuration comprises actuating the valve positioned within network of runners 206 in a close proximity to the melt inlet 202 (i.e. at a location 280) to its open configuration.

Once this step is executed, the source of molding material (i.e. the injection unit 106) is fluidly connected to the molding cavities defined between the plurality of mold cores 120 and the plurality of mold cavities 118. At this point, injection of the molding material, as is known in the art, is carried out.

### Step 320—Actuating the Downstream Melt Flow Control Device to its Blocked Configuration

The method 300 then proceeds to step 320, where the controller 180 causes actuation of the downstream melt flow control device to its blocked configuration. In the example being considered herein, actuating the downstream melt flow control device to its blocked configuration comprises actuating the plurality of valve stems 220 to a blocked configuration.

### Step 330—Actuating the Upstream Melt Flow Control Device to its Blocked Configuration

The method 300 then proceeds to step 330, where the controller 180 causes actuation of the upstream melt flow control device to its blocked configuration. Within the example being considered herein, actuating the upstream melt flow control device to its blocked configuration comprises actuating the valve positioned within network of runners 206 in a close proximity to the melt inlet 202 to its blocked configuration.

It is worthwhile noting that in some embodiments of the present invention, step 320 and step 330 can be executed substantially at the same time. In other embodiments, as will be described herein below, step 320 can be executed first and then step 330 is executed, with certain additional optional steps being executed therebetween, as will be discussed in greater detail herein below in connection with an alternative embodiments of the present invention.

Execution of step 320 and step 330 (i.e. actuating the upstream melt flow control device and actuating the downstream melt flow control device to a respective blocked configuration) results in molding material being trapped therebetween at a trapped pressure. Within the embodiments of the present invention “trapped pressure” substantially equals to a last pressurized portion of a molding cycle pressure. Within some embodiments of the present invention, step 320 and step 330 are executed after the filling step of the injection molding cycle. Within these embodiments, the last pressurized portion of a molding cycle pressure equals to the injection pressure and, as such, within these embodiments the trapped pressure substantially equals to the injection pressure. Within other embodiments, step 320 and step 330 are executed after the holding step of the injection molding cycle. Within these embodiments, the last pressurized portion of a molding cycle pressure equals to the holding pressure and, as such, within these embodiments the trapped pressure substantially equals to the holding pressure.

Just as an example and not by way of limitation, an example of pressure during various portions of the molding cycle will be presented. Dealing firstly with a preform mold, a typical pressure at the machine nozzle was observed to be approximately 400 Bar at the end of the filling step and approximately 220 Bar at the end of holding step. Similarly, a typical pressure within the first level sub-network 208 was observed to be approximately 220 Bar at the end of filling step and approximately 200 Bar at the end of holding step. It is worthwhile noting that pressure during these operations typically varies for the preform molding due to the so-called fill speed profiling.

For a typical thinwall container molding operation the following typical pressures were observed. The typical pressure at the machine nozzle was approximately 1600 Bar at the end of filling step and approximately 800 Bar at the end of holding step.

Furthermore, the trapped pressure is substantially maintained until a beginning of a next injection cycle or, in other words, the trapped pressure is prevented from any substantial pressure decay. In other words, the method 300 further includes substantially preventing melt pressure decay during the molding material trapping. Having said that, embodiments of the present invention do contemplate some level of the pressure decay, as long as the trapped pressure is maintained at a level, which is substantially above a so-called “mold decompression pressure” associated with the first mold half 114 and the second mold half 116. The mold decompression pressure is a pressure to which the molding material is typically allowed to fall to after the filling step or holding step in order to decompress the melt distribution network, as was described in the background section of this description and as will be illustrated in greater detail herein below.

Once the controller 180 executes step 320 and step 330, it returns to the execution of step 310 or in other words, repeats the injection molding cycle.

It will be recalled that in some embodiments of the present invention, step 320 and step 330 can be executed in sequence—i.e. one after the other. More specifically, within some of these embodiments of the present invention, the controller 180 first executes step 320. The controller 180 can then execute an optional step of generating additional melt pressure after actuating the downstream melt flow control device to its blocked configuration (i.e. step 320) but before actuating the upstream melt flow control device to its blocked configuration (i.e. step 330), or in other words, prior to the molding material being trapped at the trapped pressure. Generating additional melt pressure can be executed by conventional means, such as for example by increasing the speed of rotation of the screw of the injection unit 106 in those embodiments where the injection unit is implemented as a single stage injection unit or advancing the plunger of the shooting pot of the injection unit 106 in those embodiments where the injection unit is implemented as a two-stage injection unit.

This embodiment has a particular technical effect, but is not limited to, those embodiments of the present invention where step 320 and step 330 are executed at the end of filling step of the injection molding cycle. In a sense, execution of this optional step allows to re-pressurize the hot runner 200 and then trap pressure at that level, essentially alleviating the need to build up pressure at the beginning of the next injection cycle.

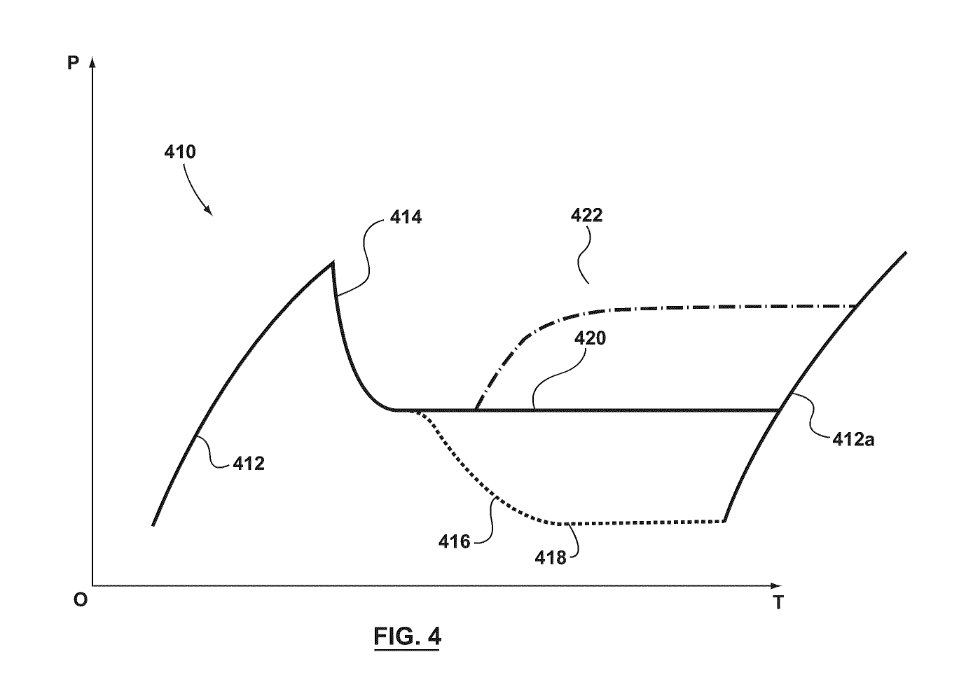

Behavior of the molding material pressure according to prior art approaches and according to embodiments of the present invention will now be illustrated in greater detail with reference to FIG. 4, which plots pressure over time and, to this extent, the X axis plots time and the Y axis plots pressure. The pressure curve 410 is illustrated. The pressure curve 410 has a first portion 412, which shows the pressure build up during filling step of the injection molding cycle. The pressure curve 410 has a second portion 414, which corresponds to the pressure during the holding step of the injection molding cycle. Portion 416 of the pressure curve 410 illustrates a pressure decay during traditional approaches of the prior art, whereby molding material pressure is allowed to decay to mold decompression pressure 418, and after a certain time interval (length of which depends primarily on the cooling time required for a given application) the pressure is caused to build up as part of the next injection molding cycle 412a. Portion 420 of the pressure curve 410 illustrates pressure behavior in certain embodiments of the present invention (particularly those, where step 320 and step 330 are executed at the end of the holding step), whereby pressure is maintained at a trapped pressure level which is substantially the same as the pressure during the holding step. Portion 422 of the pressure curve 410 illustrates pressure behavior in certain embodiments of the present invention, where molding material pressure is allowed to build up prior to being trapped.

It is clear from the illustration of FIG. 4 that a technical effect of embodiments of the present invention at least alleviates the need to cyclically build up pressure from the mold decompression pressure to a filling pressure at the beginning of each molding cycle. Accordingly, it can be said that embodiments of the present invention have a technical effect of saving energy.

It is noted that the description presented herein above makes it clear that the molding material is being trapped at a trapped pressure, which is in the range of between (i) above the mold decompression pressure and (ii) peak injection pressure associated with the first mold half 114 and the second mold half 116 (or in other words, a mold housing the melt distribution network).

It should be recalled that it is contemplated that in alternative non-limiting embodiments of the present invention, the first melt flow control device (i.e. at the upstream location) can be implemented as either a screw of the injection unit 106 in those embodiments where the injection unit 106 is implemented as a single stage injection unit and a distributor of the shooting pot of the injection unit 106 in those embodiments where the injection unit 106 is implemented as a two-stage injection unit. To complete the description of these alternative non-limiting embodiments of the present invention, modifications to the method 300 will now be described in greater detail and, in particular, modifications to step 310 and step 330 of the method 300.

Firstly, we shall describe modifications to the implementation of the method whereby the first melt flow control device is implemented as the screw of the injection unit 106 in those embodiments where the injection unit 106 is implemented as a single stage injection unit. Within these embodiments of the present invention, as part of execution of step 310, the screw of the injection unit 106 is allowed to operate in a conventional manner for the filling step and holding step of the injection molding cycle. As part of the execution of step 310, the screw of the injection unit 106 is operated such as to trap pressure between the screw of the injection unit 106 and the downstream melt flow control device.

In some embodiments of the present invention, this involves increasing the speed of rotation of the screw of the injection unit 106. In particular, within these embodiments of the present invention, as part of the recovery portion of the molding cycle, the recovery is executed with the back pressure which substantially equals to the last pressurized portion of a molding cycle pressure (i.e. the filling pressure or the hold pressure). This may require a higher speed of rotation of the screw compared to the prior art approaches to recovery. When recovery is completed, a check valve associated with the screw closes, effectively trapping pressure within the melt distribution network. In those embodiments where the screw does not have a check valve, the screw can be rotated at an adequate speed to maintain the trapped pressure at the last pressurized portion of a molding cycle pressure level.

Now turning our attention to modification to the implementation of the method whereby the first melt flow control device is implemented as the distributor and/or plunger of the shooting pot of the injection unit 106 in those embodiments where the injection unit 106 is implemented as a two-stage injection unit. Within these embodiments of the present invention, as part of execution of step 310, the distributor and/or plunger of the shooting pot is allowed to operate in a conventional manner for the filling step and holding step of the injection molding cycle. As part of the execution of step 310, the shooting pot is operated such as to trap pressure between the screw of the injection unit 106 and the downstream melt flow control device.

In particular, within these embodiments of the present invention, as part of executing recovery portion of the molding cycle, a distributor valve is actuated into a configuration suitable for transfer of the molding material into the shooting pot without first retrieving the plunger of the shooting pot to decompress the melt distribution network or, in other words, to relieve pressure within the melt distribution network, effectively trapping pressure within the melt distribution network. Within these embodiments of the present invention, the shooting pot can be re-pressurized with screw movement and rotation to balance pressure on the two sides of the distributor valve prior to actuating same.

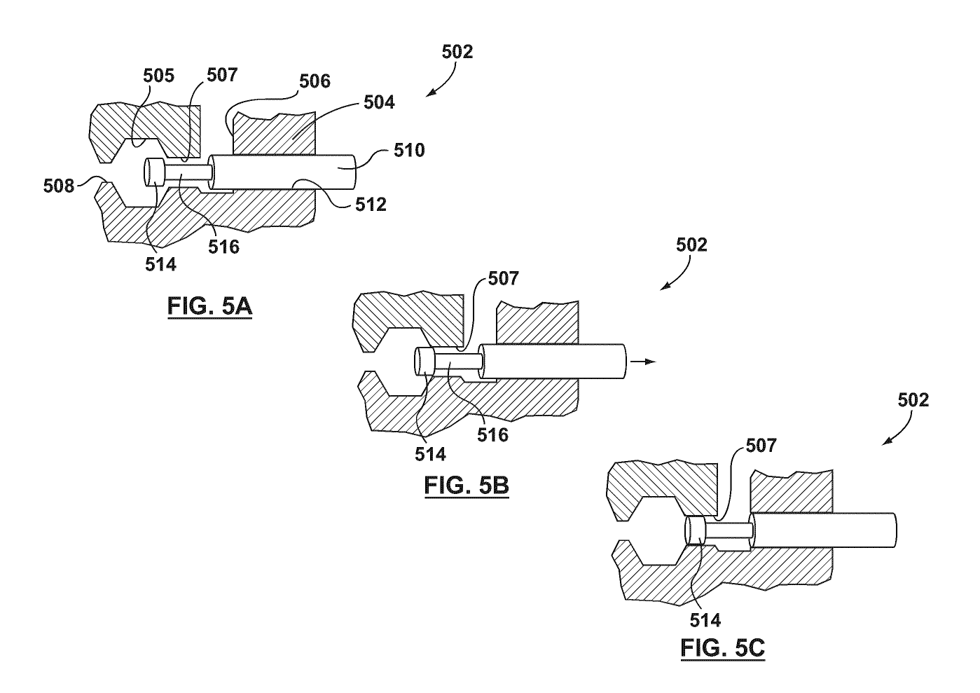

Within those embodiments of the present invention, where the downstream melt flow control device is implemented as a valve, an optional step of executing melt decompression downstream of the downstream melt flow control device can be optionally executed. Within these embodiments of the present invention, the downstream melt flow control device can be implemented as a valve 502 a non-limiting embodiment of which is depicted in FIG. 5A, FIG. 5B and FIG. 5C. Referring first to FIG. 5A, which shows an open configuration of the valve 502, the valve 502 has a body 504, the body 504 having an inlet 506 and outlet 508. Disposed between the inlet 506 and the outlet 508, are a decompression chamber 505 and a restricted flow channel 507. The valve 502 further includes a valve stem 510. The valve stem has a valve stem body 512, a restrictor 514 and a flow channel member 516, disposed between the valve stem body 512 and the restrictor 514. FIG. 5A shows the valve 502 in an open configuration, whereby the restricted flow channel 507 and the flow channel member 516 cooperate to provide a passageway for the molding material between the inlet 506 and the outlet 508. FIG. 5B shows the valve 502 in a blocked configuration, whereby the restrictor 514 and the restricted flow channel 507 cooperate to block passage for the molding material between the inlet 506 and the outlet 508. To this end, the restrictor 514 and the restricted flow channel 507 are dimensioned such that to allow the restrictor 514 to slide within the restricted flow channel 507, while substantially preventing any molding material passing through in the blocked configuration.

Finally, FIG. 5C show the valve 502 in a blocked and decompressed configuration (i.e. in a decompression configuration), whereby the restrictor 514 and the restricted flow channel 507 still cooperate to block passage for the molding material between the inlet 506 and the outlet 508, but at the same the right-bound movement (as viewed in FIG. 5C) for essentially a distance that equals to the width of the restrictor 514 has decompressed the pressure of the molding material downstream of the valve 502 by effectively drawing additional volume of material into the decompression chamber 505.

The non-limiting embodiment of the valve 502 is particularly suitable for implementing the optional step of melt decompression downstream of the valve 502. However, it should be expressly understood that other implementation for the downstream melt flow control device that would allow to execute the optional step of melt decompression are possible. An example of such an alternative configuration is disclosed, for example, in the U.S. Pat. No. 7,306,455 issued to Dewar et al on Dec. 11, 2008. In some embodiments of the present invention, the controller 180 can further implement an optional security measure. For example, the controller 180 can be configured to execute an override melt pressure relief. For example, the override melt pressure relief routine can be executed when a technician needs to service the first mold half 114 and/or the second mold half 116 during operation thereof. The override melt pressure relief routine causes the upstream melt flow control device to be actuated into an open configuration and to relieve any pressure being trapped between the upstream melt flow control device and the downstream melt flow control device. The override melt pressure relief routine can be triggered, for example, using a Human-Machine Interface of the controller 180 or, by some other trigger (for example, by opening of the protective enclosure of the molding system 100 or the like.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. A method (300) of operating a melt distribution network within a molding system (100), the melt distribution network including a first melt flow control device at an upstream location and a second melt flow control device at a downstream location, the method (300) comprising:
actuating the first melt flow control device to its open configuration and actuating the second melt flow control device to its open configuration (310) to connect a source of molding material with a molding cavity via the melt distribution network;
actuating (320) the second melt flow control device to its blocked configuration;
actuating (330) the first melt flow control device to its blocked configuration;
said actuating the second melt flow control device and said actuating the first melt flow control device to their respective blocked configurations (320, 330) resulting in molding material being trapped therebetween at a trapped pressure that substantially equals to a last pressurized portion of a molding cycle pressure, said trapped pressure being maintained until a beginning of a next injection cycle.

2. The method (300) of claim 1, wherein said actuating (320) of the second melt flow control device to its blocked configuration is executed substantially at an end of the last pressurized portion of a molding cycle.

3. The method (300) of claim 2, wherein said last pressurized portion of the molding cycle is the end of a filling step and wherein the last pressurized portion of the molding cycle pressure is an injection pressure.

4. The method (300) of claim 2, wherein said last pressurized portion of the molding cycle is the end of a holding step and wherein the last pressurized portion of the molding cycle pressure is a holding pressure.

5. The method (300) of claim 1, further comprising, substantially at the beginning of the next injection cycle after the molding material is trapped at the trapped pressure:
actuating the first melt flow control device to its open configuration and actuating the second melt flow control device to its open configuration.

6. The method (300) of claim 1, wherein said second melt flow control device comprises a valve.

7. The method (300) of claim 6, wherein said valve is positioned in a location within the melt distribution network and wherein the location is at one of:
between a plurality of melt outlets (204) and a second level sub-network (210);
within the second level sub-network (210);
between the second level sub-network (210) and a first level sub-network (208);
within the first level sub-network (208);
between the first level sub-network (208) and a molding machine nozzle.

8. The method (300) of claim 1, wherein said second melt flow control device comprises a valve stem (220) of a melt outlet (204).

9. The method (300) of claim 1, wherein said second melt flow control device comprises a plurality of second melt flow control devices.

10. The method (300) of claim 1, wherein said first melt flow control device comprises a valve.

11. The method (300) of claim 1, wherein said first melt flow control device comprises a reciprocating screw of an injection unit (106).

12. The method (300) of claim 1, wherein said first melt flow control device comprises a distributor and a plunger of a shooting pot.

13. The method (300) of claim 1, further comprising substantially preventing melt pressure decay while the molding material is being trapped at the trapped pressure.

14. The method (300) of claim 1, wherein said actuating the first melt flow control device to its blocked configuration (320) and said actuating the second melt flow control device to its blocked configuration (330) are executed at a substantially the same time.

15. The method (300) of claim 1, further comprising, prior to the molding material being trapped at the trapped pressure and after said actuating the second melt flow control device to its blocked configuration (330):
generating additional melt pressure in order to increase melt pressure from the trapped pressure to a pressure higher than the trapped pressure and lower than a peak injection pressure.

16. The method (300) of claim 1, wherein said melt distribution network and said molding system (100) are configured for processing compressible polymer material.

17. The method (300) of claim 1, wherein said trapped pressure is in a range of between above a mold decompression pressure and peak injection pressure associated with a mold housing the melt distribution network.

18. The method (300) of claim 1, further comprising during said molding material being trapped at the trapped pressure:
executing melt decompression at a location downstream from said second melt flow control device.

19. The method (300) of claim 18, wherein said executing comprises actuating the second melt flow control device to a decompression configuration.

20. A controller (180) for controlling operation of a melt distribution network within a molding system (100), the melt distribution network including a first melt flow control device at an upstream location and a second melt flow control device at a downstream location, the controller being configured to:
actuate the first melt flow control device to its open configuration and actuating the second melt flow control device to its open configuration to connect a source of molding material with a molding cavity via the melt distribution network;
actuate the second melt flow control device to its blocked configuration;
actuate the first melt flow control device to its blocked configuration;
thereby causing molding material being trapped at a trapped pressure that substantially equals to a last pressurized portion of a molding cycle pressure, said trapped pressure being maintained until a beginning of a next injection cycle.
